(19) United States
(12) Patent Application Publication
(10) Pub. No.: US 2016/0107082 A1
(43) Pub. Date: Apr. 21, 2016

(54) GAME CONTROLLER DEVICE

(71) Applicant: Inventec (Pudong) Technology Corporation, Shanghai (CN)

(72) Inventors: Lung-Hsun Song, Taipei (TW); Huei-Jiun Tang, Taipei (TW); Chia-Cheng Shih, Taipei (TW); I-Fang Chen, Taipei (TW); Kuan-Wei Lee, Taipei (TW); Chun-Yuan Huang, Taipei (TW)

(21) Appl. No.: 14/692,215

(22) Filed: Apr. 21, 2015

(30) Foreign Application Priority Data
Oct. 16, 2014 (CN) 201410548960.1

(51) Int. Cl. A63F 13/24

(52) U.S. Cl. CPC A63F 13/24

(57) ABSTRACT

A game controller device comprises an assembling component and at least one input module. The assembling component comprises a loading surface and a rear surface relative to each other. The assembling component is for accommodating an electronic device. The at least one input module comprises a control surface. The at least one input module is movably connected to a side of the assembling component to have a first using position and a second using position. The at least one input module covers the rear surface when the at least one input module is located at the first using position. The at least one input module is disengaged from the rear surface and both the control surface and the loading surface face along a same direction when the at least one input module is located at the second using position.

### CROSS-REFERENCE TO RELATED APPLICATIONS

This non-provisional application claims priority under 35 U.S.C. §119(a) on Patent Application No(s). 201410548960.1 filed in China on Oct. 16, 2014, the entire contents of which are hereby incorporated by reference.

### BACKGROUND OF THE INVENTION

1. Technical Field of the Invention

The disclosure relates to a game controller device, and more particularly to a game controller device for accommodating an electronic device to play electronic games.

2. Description of the Related Art

With the growing popularity of portable electronic products, there is a variety of portable electronic products, such as, smart phone and tablet computer, have greatly enriched people's daily lives, and people would usually bring the portable electronic products with them when going out.

Since the variety of portable electronic products has been popularized, electronic products are not only used for writing and communicating, but are for playing electronic games (i.e., video games). In such case, it is hard for users to use a built-in touch interface of the portable electronic products to handle such a complicated operation, i.e., playing electronic games.

Most manufacturers provide external hardware devices for users to be installed with the portable electronic products, thereby improving the convenience of game operations. For example, the external hardware device is an external keyboard or a joystick supporting a tablet computer. However, users have to bring not only the portable electronic product but also such a large external hardware device, which is inconvenient for the users.

### SUMMARY OF THE INVENTION

An embodiment of the disclosure provides a game controller device comprising an assembling component and at least one at least one input module. The assembling component comprises a loading surface and a rear surface relative to each other. The loading surface is for accommodating an electronic device. The at least one input module comprises a control surface. The at least one input module can be movably connected to a side of the assembling component to have a first using position and a second using position. The at least one input module covers the rear surface, and the control surface and the loading surface face along the opposite directions of the assembling component when the input module is at the first using position. The input module and the rear surface are separated from each other and both the control surface and the loading surface face along a same direction when the input module is at the second using position.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an exploded view of a game controller device and an electronic device according to a first embodiment of the disclosure;

FIG. 2 is a perspective view of the game controller device and the electronic device according to the first embodiment of the disclosure;

FIG. 3 is an exploded top perspective view of the game controller device according to the first embodiment of the disclosure;

FIG. 4A is a cross-sectional view of the input component and the slide component of FIG. 3 at the first using position;

FIG. 4B is the cross-sectional view of the input component and the slide component of FIG. 3 moved between the first using position and a second using position;

FIG. 4C is the cross-sectional view of the input component and the slide component of FIG. 3 at the second using position;

FIG. 5 is an enlarged partial cross-sectional view of the input component and the slide component of FIG. 4C;

FIG. 6 is a plan view of the game controller device and the electronic device operated by another manner according to the first embodiment of the disclosure,

FIG. 7 is a plan view of the game controller device and the electronic device operated by yet another manner according to the first embodiment of the disclosure,

FIG. 8 is a cross-sectional view of the input component and the slide component of the game controller device at the second using position according to the second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In addition, although the terms “the up, down, left, and right directions” are defined in the disclosure, the directions are defined for the sake of convenience in order to simplify the relative relationship between constituent elements. Such directional terms should not be construed to limit the scope of the disclosure in any manner.

In the disclosure, the game controller device is for being installed with an electronic device, such as, but not limited to, tablet computer, smart phone or portable electronic games console. For example, the game controller device can be applied to a protective cover of a tablet computer or a protective film of a smart phone.

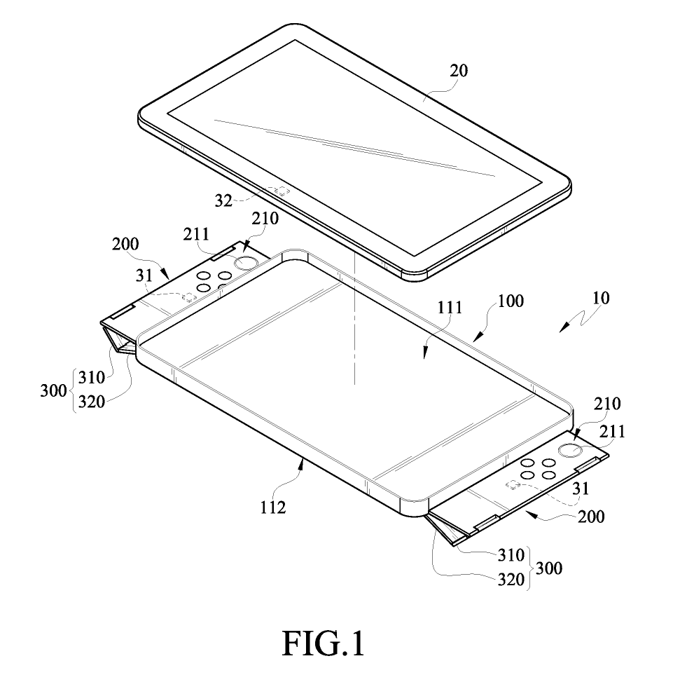

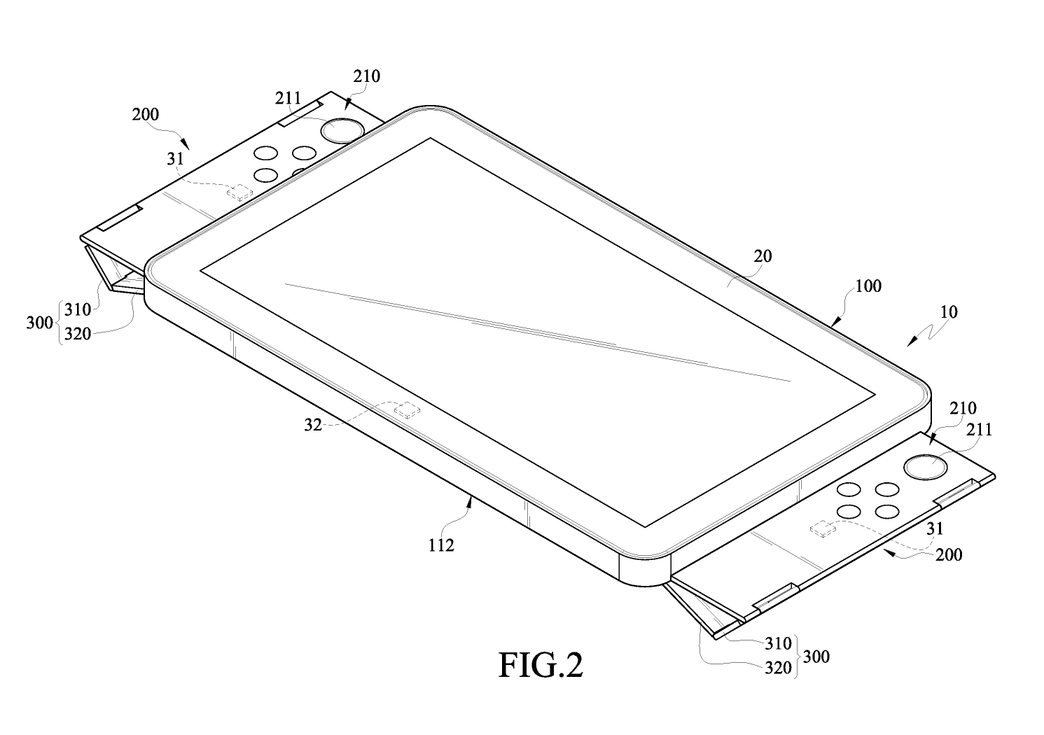

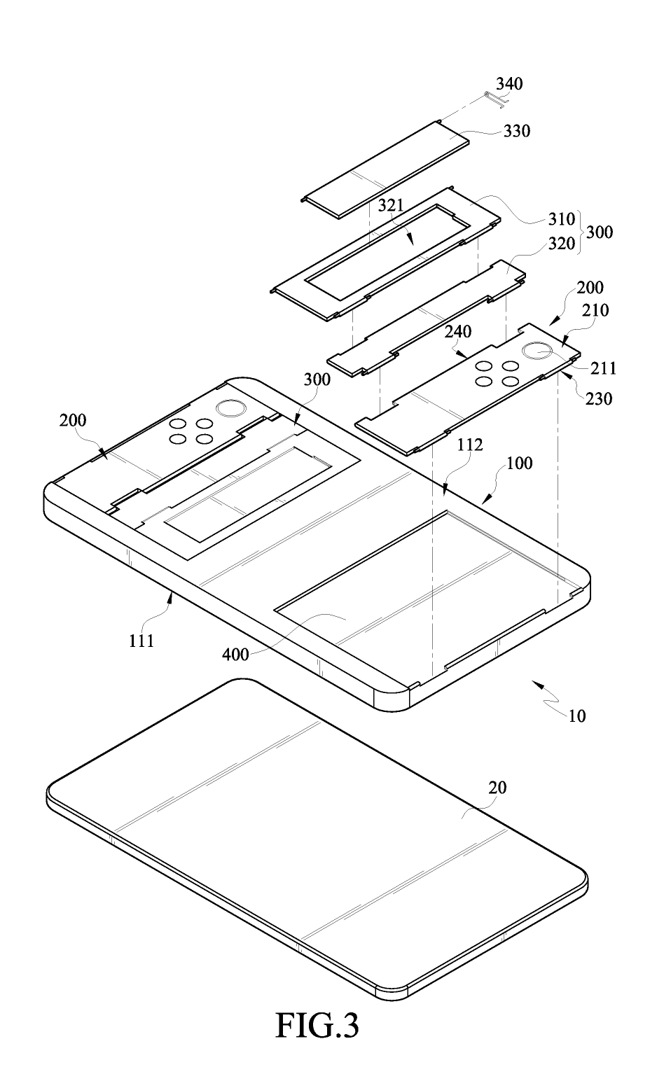

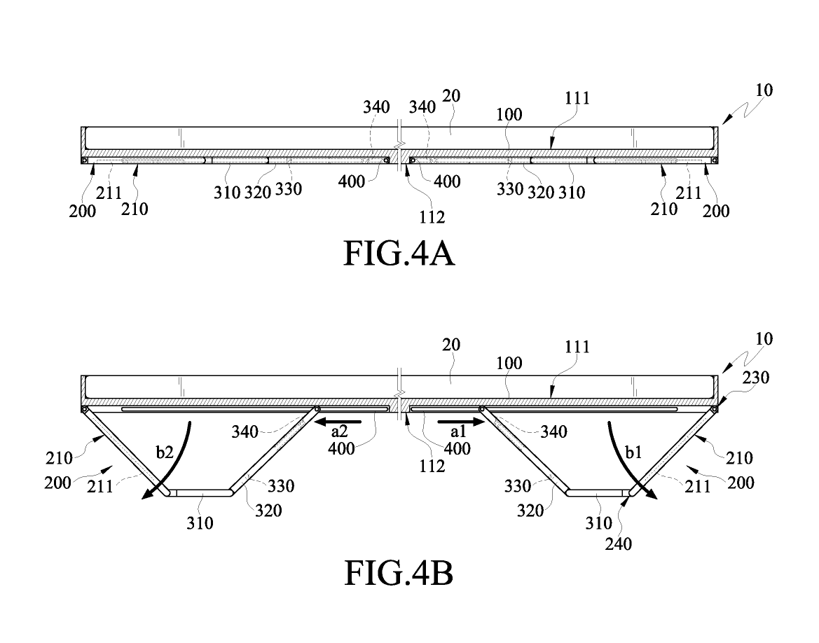

Please refer to FIG. 1 to FIG. 3. FIG. 1 is an exploded view of a game controller device and an electronic device according to a first embodiment of the disclosure. FIG. 2 is a perspective view of the game controller device and the electronic device according to the first embodiment of the disclosure. FIG. 3 is an exploded top perspective view of the game controller device according to the first embodiment of the disclosure. In this embodiment, a game controller device 10 comprises an assembling component 100 and two input modules 200. The assembling component 100 comprises a loading surface 111 and a rear surface 112 that are opposite to each other. An electronic device 20 is detachably mounted on the assembling component 100. Each of the two input modules 200 comprises a control surface 210. The two input modules 200 can comprise a plurality of buttons 211. The plurality of buttons 211 is located on the control surface 210. The assembling component 100 comprise a groove 400 located on the rear surface 112 of the assembling component 100. First side edges 230 of the two input modules 200 are directly pivotally disposed on the two side edges of the rear surface 112 of the assembling component 100 that are opposite to each other through pivots, respectively, such that the two input modules 200 are movably connected to the sides of the assembling component 100 to have a first using position as shown in FIG. 4A and a second using position as shown in FIG. 4C, respectively. The two input modules 200 are located in the groove 400 when the two input modules 200 are at the first using position. The two input modules 200 are disengaged from the groove 400 when the two input modules 200 are located at the second using position. The function of the groove 400 will be described in the following specification.

In this and some other embodiments, the game controller device 10 comprises two linkage arrangement modules 300. Each of the two linkage arrangement modules 300 comprises a first sheet 310 and a second sheet 320. Two sides of the first sheet 310 that are opposite to each other are pivotally disposed on a second edge 240 of the input module 200 and a side of the second sheet 320 through two pivots, respectively. Another side of the second sheet 320 is slidably disposed in the groove 400.

In this and some other embodiments, the linkage arrangement module 300 comprises a cover 330 and a flexible member 340. The second sheet 320 comprises a grabbed hole 321. For example, the flexible member 340 is a torsion spring. The cover 330 is located within the grabbed hole 321 and pivotally disposed on the second sheet 320. The two sides of the flexible member 340 that are opposite to each other are connected to the cover 330 and the second sheet 320, respectively, such that the cover 330 normally covers the grabbed hole 321.

In this embodiment, the input module 200 is pivotally disposed on the side edge of the rear surface 112 through the pivot. The first sheet 310 and the second sheet 320 of the linkage arrangement module 300 are pivotally disposed on the second sheet 320 and the input module 200 through pivots, respectively, such that the first sheet 310 and the second sheet 320 can flip over with respect to the assembling component 100, but the disclosure is not limited to the configuration of the first sheet 310 and the second sheet 320. In some other embodiments, the input module 200, the second sheet 320 and the first sheet 310 are connected to the rear surface 112, the input module 200 and the first sheet 310 through flexible components, respectively, such that the input module 200, the second sheet 320 and the first sheet 310 can flip over with respect to the assembling component 100. In this embodiment, for example, the quantity of the input module 200 is, but not limited to, two. In some other embodiments, the quantity of the input module 200 is one.

In this embodiment, the input module 200 comprises a wireless transmission module 31. The electronic device 20 comprises an electrical signals receiver 32 corresponding to the wireless transmission module 31. The electrical signals receiver 32 is for receiving output electrical signals from the wireless transmission module 31. The wireless transmission module 31 is for receiving the output electrical signals from the buttons of the input module 200. Users can therefore output electrical signals to the electronic device 20 via the buttons 211, and can input the electrical signals to the electronic device 20 via the wireless transmission module 31 and the electrical signals receiver 32. In other words, the input module 200 has a joystick-like function. In this embodiment, the input module 200 is for transmitting electrical signals to the electronic device 20 via the wireless transmission manner, the disclosure is not limited to the wireless transmission. In some other embodiments, the input module 200 can be electrically connected to the electronic device 20 via a signal transmission cable, and the input module 200 therefore transmits electrical signals via the cable transmission manner.

Please refer to FIG. 4A, FIG. 4B and FIG. 4C. FIG. 4A is a cross-sectional view of the input component and the slide component of FIG. 3 at the first using position. FIG. 4B is the cross-sectional view of the input component and the slide component of FIG. 3 moved between the first using position and a second using position. FIG. 4C is the cross-sectional view of the input component and the slide component of FIG. 3 at the second using position. In this embodiment, both the linkage arrangement module 300 and the input module 200 are located in the groove 400 when the input module 200 is located at the first using position. The input module 200 covers the rear surface 112. The control surface 210 and the loading surface 111 face along the two opposite normal lines of the two sides of the assembling component 100, respectively. Moreover, the first sheet 310 is parallel to the second sheet 320 at this time. A user can push the second sheet 320 to slide relative to the groove 400 when the user is going to move the input module 200 from the first using position as shown in FIG. 4A to the second using position as shown in FIG. 4C. In this embodiment, the two second sheets 320 of the two linkage arrangement modules 300 respectively slide along the direction a1 and direction a2 relative to the two grooves 400. Because the input module 200 is pivotally disposed on the first sheet 310, and the first sheet 310 is pivotally disposed on the second sheet 320, the first sheet 310 and the input module 200 can be moved relative to the assembling component 100 when the user pushes the second sheet 320. Therefore, the two input modules 200 pivotally rotate along the direction b1 and the direction b2 toward the side edges of the rear surface 112, respectively, before move to the second using position. At this time, the rear surface 112 and the input module 200 are disengaged from each other, and the control surface 210 of the input module 200 and the loading surface 111 face along the same normal line of the assembling component 100. In addition, the input module 200, the first sheet 310 and the second sheet 320 form an angle to construct a gripping part to provide user to grip, hold and use the game controller device 10 easily.

It is convenient for users to bring the electronic device 20 and the game controller device 10 together because the game controller device 10 can accommodate the electronic device 20, and has the joystick-like function. Therefore, user can use the game controller device 10 to operate the electronic device 20 to play electronic games without bringing extra external hardware devices.

In this embodiment, the game controller device 10 comprises the linkage arrangement module 300, but the disclosure is not limited to the game controller device 10 with the linkage arrangement module 300. In some other embodiments, the game controller device 10 comprises the input module 200 without any linkage arrangement module 300. A user can directly flip the input module 200 over to have the input module 200 being selectively located at the first using position or the second using position.

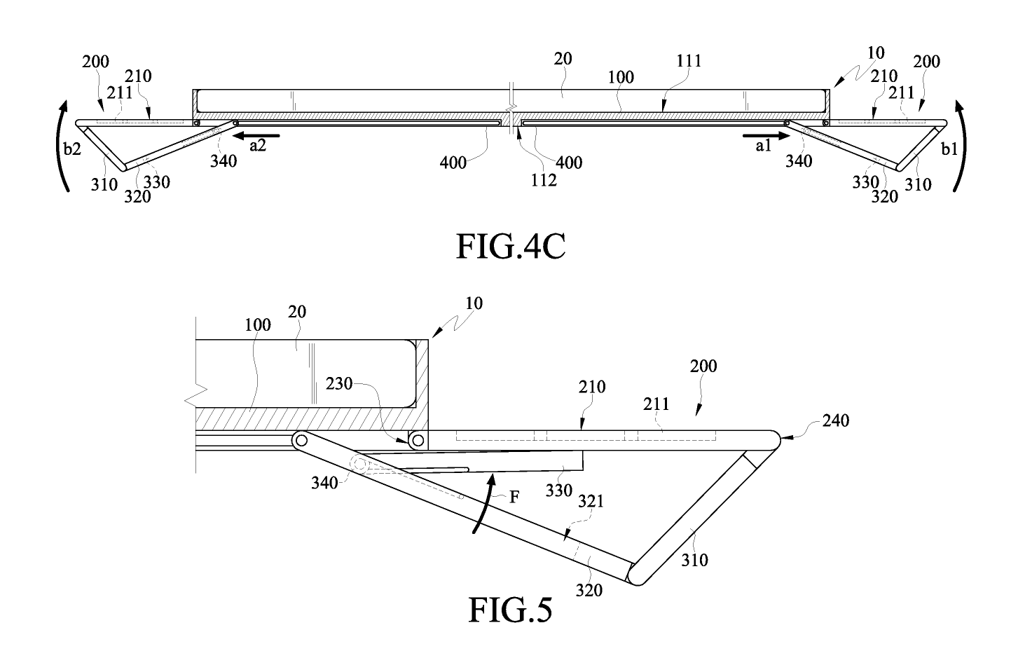

Please refer to FIG. 5. FIG. 5 is an enlarged partial cross-sectional view of the input component and the slide component of FIG. 4C. In this embodiment, the input module 200, the first sheet 310 and the second sheet 320 together form the gripping part with a room when the input module 200 is at the second using position. The cover 330 is pivotally rotated relative to the flexible member 340 and located in the room of the gripping part when the cover 330 is forced by an external force F, e.g., being pushed by a finger. When the external force F applied to the cover 330 disappears, the cover 330 returns to the grabbed hole 321 to close the grabbed hole 321 by the elastic force provided by the flexible member 340. Therefore, a user can push the cover 330 to be located in the room of the gripping part, such that a finger of a user can insert into the room of the gripping part. Thus, a user would feel more comfortable, and can firmly grip and hold the game controller device 10 when using it.

In this embodiment, the linkage arrangement module 300 comprises the cover 330 and the flexible member 340, but the disclosure is not limited to the linkage arrangement module 300 with the cover 330 and the flexible member 340. In some other embodiments, the linkage arrangement module 300 does not comprise the cover 330 and the flexible member 340, a user can insert his/her finger into the grabbed hole 321 directly.

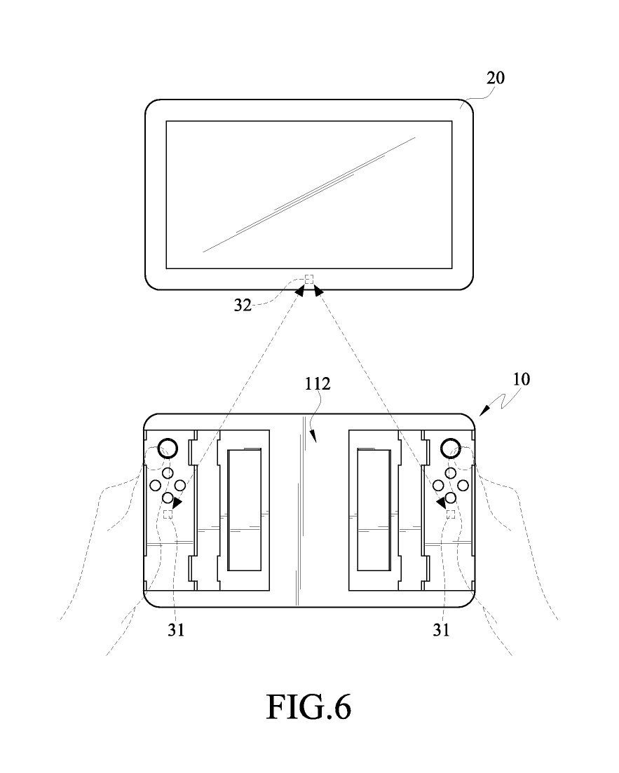

FIG. 6 is a plan view of the game controller device and the electronic device operated by another manner according to the first embodiment of the disclosure.

In the previous embodiments, user can input electrical signals to the electrical signals receiver 32 of the electronic device 20 to operate the electronic device 20 via the control surface 210 and the wireless transmission module 31 after the electronic device 20 is detachably disposed on the loading surface 111 of the game controller device 10 and the input module 200 is moved to the second using position.

In present embodiment, it has another manner for using the game controller device 10. In this embodiment, the electronic device 20 is detached from the assembling component 100 of the game controller device 10, and the input module 200 is at the first using position. Because the electronic device 20 and the game controller device 10 are disengaged from each other, a user therefore can directly input signals by using the buttons 211 of the input module 200 that are at the first using position, and can input electrical signals to operate the electronic device 20 through the wireless transmission module 31 and the electrical signals receiver 32.

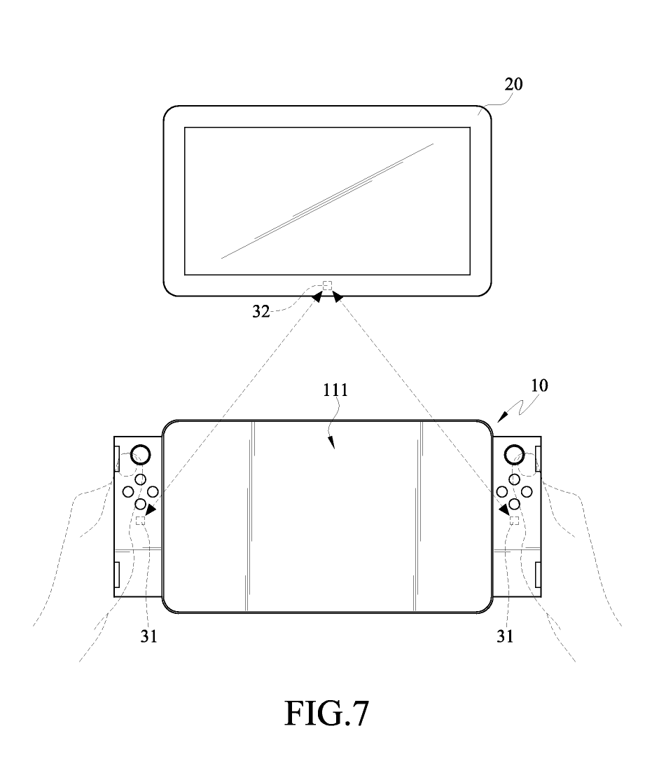

Please refer to FIG. 7. FIG. 7 is a plan view of the game controller device and the electronic device operated by yet another manner according to the first embodiment of the disclosure. In this embodiment, it has further another manner for using the game controller device 10. The electronic device 20 is detached from the assembling component 100 of the game controller device 10, and the input module 200 is at the second using position. User can directly input signals by using the buttons 211 of the input module 200 that are at the second using position, and can therefore to operate the electronic device 20 via the wireless transmission module 31 and the electrical signals receiver 32.

In addition, in some other embodiments, the game controller device 10 further comprises a sensing component, such as infrared detector. When sensing that the electronic device 20 is disposed on the loading surface 111 of the assembling component 100 and the input module 200 is at the first using position, the sensing component triggers an inner control element to turn off the function of inputting electrical signals input of the buttons 211 of the input module 200. When sensing that the electronic device 20 is detached from the loading surface 111 or when the input module 200 is at the second using position, the sensing component triggers the inner control element to turn on the buttons 211 of the input module 200. In other words, the sensing component can determine whether the buttons 211 is on or off according to the corresponding positions of the electronic device 20 and the input module 200 therefore, it can prevent the button 211 from being accidentally touched to unexpectedly operate the electronic device 20 in a storage condition that the electronic device 20 is disposed on the loading surface 111 and the input module 200 is at the first using position.

As described above, in the disclosure, the game controller device 10 comprises at least three manners of operation to a user to control the electronic device 20. In the first manner, the electronic device 20 is disposed on the loading surface 111, and the input module 200 is at the second using position. In the second manner, the electronic device 20 is detached from the loading surface 111, and the input module 200 is at the first using position. In the third manner, the electronic device 20 is detached from the loading surface 111, and the input module 200 is at the second using position. Therefore, user can select appropriate manners of using the game controller device 10 according to different usage conditions.

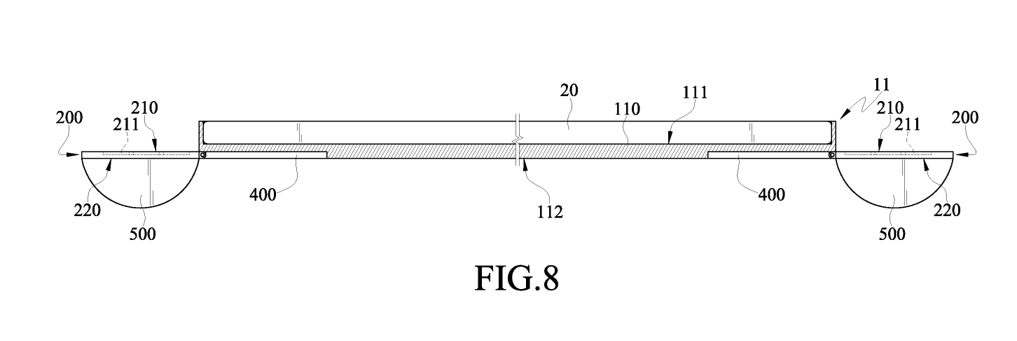

Please refer to FIG. 8. FIG. 8 is a cross-sectional view of the input component and the slide component of the game controller device at the second using position according to the second embodiment of the disclosure. In this embodiment, only differences from the first embodiment will be explained because the second embodiment is similar to the first embodiment.

This embodiment provides a game controller device 11. Compared with the previous embodiments, the differences are that the game controller device 11 comprises two inflatable-bags 500. The input module 200 of the game controller device 11 comprises an installation surface 220, and the installation surface 220 faces away from the control surface 210. The inflatable-bag 500 is located on the installation surface 210. The interior of the inflatable-bag 500 can be filled with gas. When the input module 200 is at the first using position, the inflatable-bag 500 does not have any gas such that both the inflatable-bag 500 and the input module 200 can be located in the groove 400. It is convenient for a user to selectively fill the gas with the inflatable-bag 500 to expand the volume of the inflatable-bag 500 when the input module 200 is at the second using position, and both the inflatable-bag 500 and the input module 200 expose the rear surface 112. Therefore, the gas in the interior of the inflatable-bag 800 forms a gripping part, user would feel more comfortable and can firmly grip the game controller device 11 when using it.

In the game controller device according to the embodiments of the disclosure, the two input modules are respectively connected to the side edges of a rear surface that are opposite to each other, such that the input module is movably connected a side of the assembling component to have a first using position and a second using position. When the input module is located at the first using position, the input module covers the rear surface, and a control surface and a loading surface face along the opposite normal lines of the two sides of the assembling component, respectively. When the input module is located at second using position, the input module exposes the rear surface, and the control surface and the loading surface face the along the same normal line of the assembling component. It is convenient for a user to bring the electronic device and the game controller device at the same time in a compact size because the game controller device can accommodate and load the electronic device as well as provide joystick-like function. Therefore, user can use the game controller device to operate the electronic device to platy electronic games without bringing extra external hardware devices.

Another manner of using the game controller device as described in the disclosure is that the electronic device is detached from the assembling component of the game controller device, and the input module is at the first using position. The other manner of using the game controller device is that the electronic device is detached from the assembling component of the game controller device, and the input module is at the second using position. Therefore, user can select appropriate manners of using the game controller device according to different usage conditions.

What is claimed is:

1. A game controller device comprising:
an assembling component comprising a loading surface and a rear surface relative to each other, the assembling component being for accommodating an electronic device; and
at least one input module comprising a control surface, the at least one input module being movably connected to a side of the assembling component to have a first using position and a second using position, the at least one input module covering the rear surface when the at least one input module is located at the first using position, and the at least one input module being disengaged from the rear surface and both the control surface and the loading surface facing along a same direction when the at least one input module is located at the second using position.

2. The game controller device according to claim 1, wherein the at least one input module is pivotally disposed on a side edge of the rear surface.

3. The game controller device according to claim 1, wherein the quantity of the at least one input module is two, and the two input modules are pivotally disposed on the two side edges of the rear surface, respectively.

4. The game controller device according to claim 1, wherein the assembling component comprises a groove located on the rear surface, the at least one input module is located in the groove when the at least one input module is at the first using position, and the at least one input module is disengaged from the groove when the at least one input module is at the second using position.

5. The game controller device according to claim 4, further comprising a linkage arrangement module, the linkage arrangement module comprising a first sheet and a second sheet, the first sheet being pivotally disposed on the at least one input module, a side of the second sheet being pivotally disposed on the first sheet, another side of the second sheet being slidably disposed in the groove, the first sheet being parallel to the second sheet when the at least one input module is at the first using position, and the first sheet and the second sheet form an angle together to construct a gripping part when the at least one input module is at the second using position.

6. The game controller device according to claim 5, wherein the second sheet includes a grabbed hole.

7. The game controller device according to claim 6, wherein the linkage arrangement module further comprises a cover and a flexible member, the cover is located within the grabbed hole and is pivotally disposed on the second sheet, the two sides of the flexible member that are opposite to each other are movably connected to the cover and the second sheet, respectively, such that the cover normally closes the grabbed hole.

8. The game controller device according to claim 1, wherein the at least one input module comprises a wireless transmission module electrically coupled to the electronic device.

9. The game controller device according to claim 1, further comprising an inflatable-bag, wherein the at least one input module includes an installation surface, the installation surface faces away from the control surface, and the inflatable-bag is located on the installation surface.

10. The game controller device according to claim 1, wherein the at least one input module comprises a plurality of buttons, the plurality of buttons is located on the control surface.
